(19) United States
(12) Patent Application Publication
(10) Pub. No.: US 2026/0275765 A1
(43) Pub. Date: Sep. 17, 2026

(54) A LOCKING DEVICE FOR INFLATABLE VEHICLES

(71) Applicant: IKONYX LIMITED, Whitchurch Hampshire (GB)

(72) Inventor: Austen Miller, Whitchurch Hampshire (GB)

(21) Appl. No.: 19/472,317

(22) PCT Filed: Mar. 28, 2024
(86) PCT No.: PCT/GB2024/050867

§ 371 Date: Oct. 3, 2025

(30) Foreign Application Priority Data
Apr. 3, 2023 (GB) 2304920.8

(51) Int. Cl. E05B 37/02; E05B 73/00; F16K 35/10

(52) U.S. Cl. CPC E05B 37/02; E05B 73/0005; E05B 73/007; F16K 35/10

(57) ABSTRACT

There is described a locking device for inflatable vehicles. The locking device comprises a body including a cover and an underside, and a connector configured for rotational connection. The connector extends from the underside and is rotationally coupled to the body via a locking mechanism, such that when the locking device is in an unlocked setting, the locking mechanism couples the body and the connector in an engaged configuration such that rotation of the body causes the connector to rotate with the body, and when the locking device is in a locked setting, the locking mechanism couples the body and the connector in a disengaged configuration such that rotation of the body does not cause the connector to rotate with the body.

### FIELD OF INVENTION

The present invention relates to a locking device for inflatable vehicles, such as inflatable water vehicles like stand up paddleboards, kayaks and dinghies. In particular, the present invention relates to a locking device for rotationally engaging with an air valve of the inflatable vehicle such that the inflatable vehicle may then be secured to an immovable object, thereby preventing theft of the inflatable vehicle.

### BACKGROUND

Inflatable vehicles, such as stand up paddleboards (SUPs), kayaks, canoes, dinghies and boats, are a popular source of entertainment across the world. Their ease of portability and storage makes them an attractive choice for people of all ages and abilities.

Also, their increase in popularity and ease of portability can make them an ideal target for thefts. For example, inflatable vehicles are popular in places like the beach, at lakes and along rivers, where there is not necessarily always a secure building to lock up the inflatable vehicle when not in use. Alternatively, the inflatable vehicle could be secured to an immovable object using a tether, such as a rope or chain. However, the tether must be securely fastened to the inflatable vehicle, which presents a problem.

One solution is to attach a locking device to the fin box of a paddleboard, as described in in US Patent Application No. 2017/0175425. A support body having a cubical frame engages with the fin box of the paddleboard to provide an anchor point to allow the paddleboard to be tethered to an immovable object. However, securing the support body to the paddleboard requires disassembly of the fin from the fin box which is time consuming. Leaving the support body in place is undesirable because the support body sits below the water line and so affects the hydrodynamic performance of the paddleboard.

There is, therefore, a need to provide an improved locking device for inflatable vehicles that is lightweight, portable and provides a secure lock.

### SUMMARY

According to a first aspect, the present invention resides in a system comprising an inflatable vehicle and a locking device. The locking device may be used to secure the inflatable vehicle. The locking device is configured to lock itself to the inflatable vehicle, such that the locking device thereby provides a secure anchor point that may be used to prevent theft of the inflatable vehicle. For example, a tether may be secured to the anchor point and used to tether the inflatable vehicle to an immovable object.

The inflatable vehicle comprises an air valve. The locking device comprises a body, including a cover and an underside, and a connector configured for rotational connection with the air valve. The connector extends from the underside of the body. This allows the locking device to be connected to the inflatable vehicle. For example, the connector may comprise a screw thread that co-operates with a screw thread of the air valve, or the connector may comprise a bayonet fitting sized and shaped to connect with the air valve. There is a standard type of air valve provided in inflatable water craft such as kayaks, canoes and SUPs to allow for their inflation and deflation, which is usually referred to as a Halkey Roberts-type valve. These types of valves are closed with a stopper having a bayonet connector, and the bayonet connector of the locking device may have a corresponding design.

When the locking device is connected to the air valve via the connector, the body of the locking device may conceal the air valve and the connector, preventing access to both. This may be achieved by the body having a size and shape larger than the air valve and the connector having a depth such that, when the locking device is in the air valve, the underside of the body is flush or substantially flush with the air valve and the outer surface of the inflatable vehicle adjacent the air valve.

To ensure that the locking device can be secured to the inflatable vehicle, the locking device is provided with two settings, one in which rotating the body drives the connector such that the locking device can be disconnected from the air valve, and another in which rotating the body does not drive the connector such that the locking device remains securely connected to the air valve.

This is achieved by the connector being rotationally coupled to the body via a locking mechanism. When the locking device is in the unlocked setting, the locking mechanism couples the body and the connector in an engaged configuration such that rotation of the body causes the connector to rotate with the body. This allows the body to be rotated to connect and disconnect the locking device from the inflatable vehicle. When the locking device is in the locked setting, the locking mechanism couples the body and the connector in a disengaged configuration such that rotation of the body does not cause the connector to rotate with the body. Hence, in this locked setting, if someone rotates the body to try and remove the locking device from the air valve, the body freely rotates without driving the connector such that the locking device remains securely locked to the inflatable vehicle.

The locking mechanism may comprise mechanically interlocking formations that are configured to be moved between the engaged configuration in which they interlock to ensure the connector rotates with the body, and the disengaged configuration in which the interlocking formations are clear of each other to ensure that the rotation of the body does not cause the connector to rotate with the body.

The interlocking formations may comprise a platform joined to the connector so as to rotate with the connector, a roller supported by the platform, and a retainer joined to the body so as to rotate with the body. The platform is provided with a track across which the roller may roll as the body is rotated relative to the connector when the locking mechanism is in the disengaged configuration. The track includes a radially-extending groove sized to receive at least a portion of the roller therein. The retainer is arranged to face the groove and to move between the engaged and disengaged configurations. In the disengaged configuration, the portion of the retainer aligned with the groove provides sufficient clearance for the roller to roll out from the groove, around the track and back into the groove such that the connector does not rotate with body as the body is rotated. In the engaged configuration, the portion of the retainer aligned with the groove restricts the clearance of the roller in the groove thereby preventing the roller from rolling out of the groove such that the connector rotates with the body as the body is rotated.

The surface of the retainer facing the groove may be stepped to provide a pocket flanked by raised sections and the retainer may be arranged to translate between the engaged and disengaged configurations. In the disengaged configuration, the pocket is aligned with the groove to provide the clearance for the roller to roll out from the groove. The raised sections to each side of the pocket act to retain the roller as it rolls around the track on the platform. In the engaged configuration, one of the raised sections is aligned with the groove so as to prevent the roller from rolling out of the groove. The retainer may be resiliently biased towards the engaged configuration.

Optionally, the platform may comprise further radially-extending grooves such that, when the locking mechanism is in the disengaged configuration, the roller may roll from groove to groove as the body is rotated relative to the connector. With multiple grooves, generally the body need not be turned so far to return the roller to a groove and allow the locking device to be set back in the unlocked setting.

The retainer may be moved between the engaged and disengaged configurations by an actuator. For example, the cover may further comprise an aperture that opens into a chamber within the body. The chamber may be defined in part by the retainer, and the retainer may be configured to translate from the engaged configuration to the disengaged configuration when the actuator is pushed into the chamber. The actuator may be a part of the body, for example a button, or may be a separate part, for example an end of a tether. The other end of the tether may comprise a loop, such that the tether may be passed around an immovable object such as a tree or lamppost, thereby securing the inflatable vehicle to the immovable object. The tether may be a cable, rope, cord, chain or strap.

The locking mechanism may further comprise a movable barrier configured to be moved in and out of the path of the actuator as the actuator is pushed through the chamber. The movable barrier may be controlled by a lock. In the lock's locked position, the lock prevents the movable barrier from being moved out of the actuator's path. In the lock's unlocked position, the lock allows the movable barrier to be moved out of the actuator's path.

The movable barrier may be resiliently biased towards the lock's locked position. The actuator may comprise a head that moves the movable barrier as the actuator is pushed through the chamber when the lock is set in the unlocked position. The actuator may also comprise a neck that follows the head through the chamber, wherein the neck allows the movable barrier to move back due to the resilient biasing. The movable barrier moving into the neck retains the actuator in the disengaged configuration when the lock is set to the locked position.

Optionally, the lock comprises a combination lock. The combination lock may be positioned in the cover of the body, and may include a set of rotatable dials that extend through the cover. The dials may rotate to set the position of respective recesses, and the movable barrier may comprise a finger for each of the dials. When the combination is set correctly, the lock's unlocked position is set in which the recesses are aligned to receive the fingers as the movable barrier moves out of the path of the actuator. When the combination is set incorrectly, the lock's locked position is set in which at least one of the recesses is not aligned to receive a respective finger such that the movable barrier cannot move out of the path of the actuator. Thus, the actuator may be pushed into the chamber only when the combination lock is correctly set to the lock's unlocked position. Moreover, the actuator may be pulled out from the chamber only when the combination lock is correctly set to the lock's unlocked position. In the locked position, the non-aligned recesses prevent the movable barrier from moving out of the way of the actuator.

The locking device may also comprise a mechanism that allows the combination of the combination lock to be changed. For example, the combination lock may comprise a series of dials, such as four dials, each numbered from 0 to 9. A user may then select a memorable four digit code for the combination lock.

To allow the combination to be changed, the body of the locking device may further comprise a reset switch configured to reset the combination lock, and the reset switch may be located on the underside of the body or within the connector. This prevents access to the reset switch when the locking device is locked in place in the air valve of the inflatable vehicle. For example, the reset switch may be rotatable and located within the centre of a bayonet fitting of the connector, and may be arranged to be accessed by a screwdriver or the like.

The dials may sit on indexed barrels that include the recesses, and the reset switch may be turned to a reset position to move a clamp that then allows the dials to move clear of their barrels and to be rotated independently of the barrels to set a new combination. The reset switch may be turned back out of the reset position such that the dials are moved back onto their barrels by the clamp in the newly-set combination. Optionally, the barrier co-operates with the clamp such that the clamp may only move into the reset position when the locking mechanism is in the disengaged configuration. This prevents the combination from being changed when the actuator is not pushed into the chamber.

The inflatable vehicle may be an inflatable boat, for example a canoe, a kayak or a stand-up paddle board.

The present invention also extends to the locking device alone. Hence, from a second aspect, the present invention also resides in a locking device comprising: a body including a cover and an underside; and a connector configured for rotational connection. The connector extends from the underside and is rotationally coupled to the body via a locking mechanism, such that: when the locking device is in an unlocked setting, the locking mechanism couples the body and the connector in an engaged configuration such that rotation of the body causes the connector to rotate with the body; and, when the locking device is in a locked setting, the locking mechanism couples the body and the connector in a disengaged configuration such that rotation of the body does not cause the connector to rotate with the body. In the unlocked setting, rotation of the body drives rotation of the connector such that the locking device may be attached to and removed from an item comprising a co-operating connector part. In the locked setting, rotation of the body is decoupled from the connector such that the connector does not turn with the body. Hence, rotation of the body will not disconnect the locking device from an item comprising a co-operating connector part.

Optionally, the connector comprises a screw thread. Alternatively, the connector comprises a bayonet fitting. The bayonet fitting may be sized and shaped to connect with a standard inflatable boat fill and deflate valve such as a Halkey Roberts-type valve. The cover may have a size and shape larger than the valve and the connector has a depth such that, when the locking device is in the valve and in the locked setting, the underside of the body is substantially flush with the valve, thereby making the connector inaccessible.

The locking mechanism may comprise mechanically interlocking formations that are configured to be moved between the engaged configuration where they interlock to ensure the connector rotates with the body, and the disengaged configuration where the interlocking formations are clear of each other to ensure that the rotation of the body does not cause the connector to rotate with the body.

The interlocking formations may comprise: a platform joined to the connector so as to rotate with the connector; a roller supported by the platform; and a retainer joined to the body so as to rotate with the body. The platform may be provided with a track across which the roller may roll as the body is rotated relative to the connector when the locking mechanism is in the disengaged configuration. The track may include a radially-extending groove sized to receive at least a portion of the roller therein. The retainer may be arranged to face the groove and to move between the engaged and disengaged configurations. In the disengaged configuration, the portion of the retainer aligned with the groove may provide sufficient clearance for the roller to roll out from the groove, around the track and back into the groove such that the connector does not rotate with body as the body is rotated. In the engaged configuration, the portion of the retainer aligned with the groove may restrict the clearance of the roller in the groove thereby preventing the roller from rolling out of the groove such that the connector rotates with the body as the body is rotated.

The surface of the retainer facing the groove may be stepped to provide a pocket flanked by raised sections. The retainer may be arranged to translate between the disengaged configuration in which the pocket is aligned with the groove to provide the clearance for the roller to roll out from the groove, and the engaged configuration in which one of the raised sections is aligned with the groove so as to prevent the roller from rolling out of the groove.

The platform may comprise further radially-extending grooves such that, when the locking mechanism is in the disengaged configuration, the roller may roll from groove to groove as the body is rotated relative to the connector. The roller is retained by the pocket as it rolls from groove to groove.

The cover may further comprise an aperture opening into a chamber within the body defined in part by the retainer, and the retainer is configured to translate from the engaged configuration to the disengaged configuration when an actuator is pushed into the chamber. The retainer may be resiliently biased towards the engaged configuration.

The locking device may further comprise a movable barrier configured to be moved in and out of the path of the actuator as the actuator is pushed through the chamber, wherein the movable barrier is controlled by a lock which, in the lock's locked position, prevents the movable barrier from being moved out of the actuator's path and, in the lock's unlocked position, allows the movable barrier to be moved out of the actuator's path. The movable barrier may be resiliently biased towards the locked position. The actuator may comprise a head that moves the movable barrier as the actuator is pushed through the chamber and a neck that allows the movable barrier to move back due to the resilient biasing thereby keeping the retainer in the disengaged configuration when the lock is set to the locked position.

The lock may comprise a combination lock positioned in the cover of the body, the combination lock including a set of rotatable dials that rotate to set the position of respective recesses, the movable barrier comprises a finger for each of the dials and, when the combination is set correctly, the lock's unlocked position is set in which the recesses are aligned to receive the fingers as the movable barrier moves out of the path of the actuator and, when the combination is set incorrectly, the lock's locked position is set in which at least one of the recesses is not aligned to receive a respective finger such that the movable barrier cannot move out of the path of the actuator.

The body of the locking device may further comprise a reset switch configured to reset the combination lock, and the reset switch may be located on the underside of the body or within the connector. The dials may sit on indexed barrels that include the recesses, and the reset switch may be turned to a reset position to move a clamp that then allow the dials to move clear of their barrels and rotate independently of the barrels to set a new combination, and the reset switch may be turned back out of the reset position such that the dials are moved back onto their barrels by the clamp in the newly-set combination. The barrier may co-operate with the clamp such that the clamp may only move into the reset position when the locking mechanism is in the disengaged configuration.

In other examples, the actuator may not include any form of loop or attachment for securing the inflatable vehicle to an immovable object. Rather, the actuator forms part of the body. The body may include a motion sensor with an alarm. The alarm may be configured to send visual or audible signals when the motion sensor detects movement.

The locking device may further comprise a tracking device configured to send tracking signals, thus enabling a user to keep track of the device's location. For example, the tracking signals may be Bluetooth and/or RFID signals.

### LIST OF FIGURES

In order that the invention can be more readily understood, reference will now be made by way of example only, to the accompanying drawings in which:

FIG. 1 shows an inflatable vehicle 200 secured to a tree using a locking device and a tether;

FIGS. 2A and 2B are perspective views of the locking device of FIG. 1 from above and below respectively;

FIG. 3 is a sectional perspective view of a valve body of an air valve of an inflatable vehicle 200 like that shown in FIG. 1;

FIGS. 4A to 4C are perspective views from below of the locking device of FIG. 1 being fastened to the valve body of FIG. 1;

FIG. 5 is an exploded view of the locking device 100 of FIG. 1 and an end of the tether of FIG. 1;

FIGS. 6A and 6B are sectional perspective views of the locking device of FIG. 1 that show the locking mechanism in the unlocked setting;

FIGS. 7A to 7C are sectional perspective views of the locking device of FIG. 1 that show the locking mechanism in the locked setting;

FIG. 8 is an exploded view of some parts of the locking device 100 of FIG. 1 to show components of the locking device;

FIG. 9 is a perspective view of the locking device of FIG. 1 from below to show a reset switch of a reset mechanism used to reset the combination of the combination lock;

FIGS. 10A and 10B are side sectional perspective views of the locking device of FIG. 1 that show the reset mechanism in more detail;

FIG. 11 is a sectional perspective view of part of the reset mechanism of FIG. 10 shown from below; and

FIG. 12 is a side sectional perspective view of the locking device of FIG. 1 that shows the reset mechanism set such that a new combination may be entered.

### DETAILED DESCRIPTION

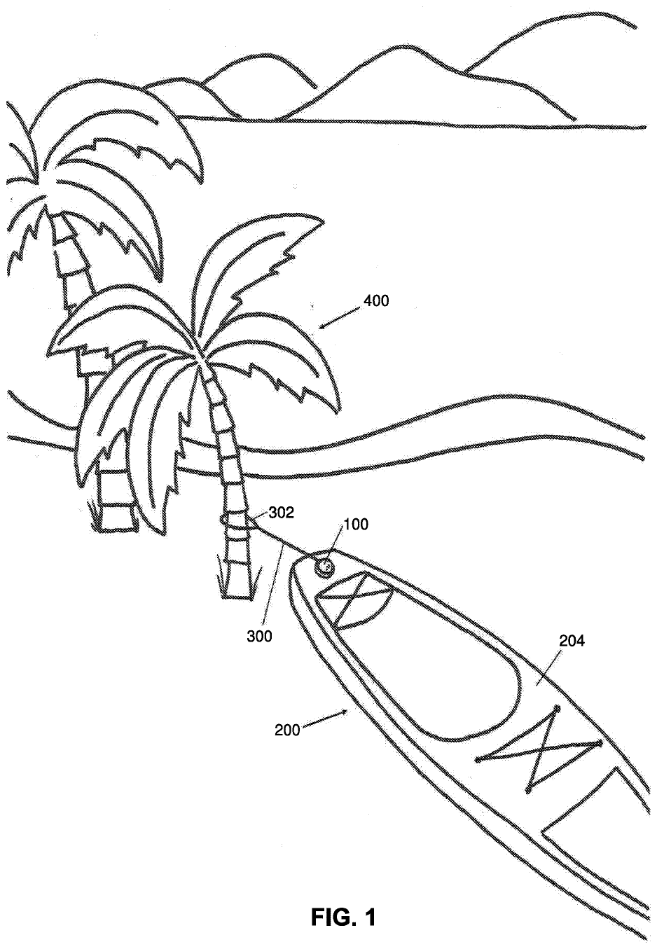

The present invention relates to a locking device 100 for securing an inflatable vehicle 200, as shown in FIG. 1. The inflatable vehicle 200, in this case a stand up paddleboard, has an air valve 202 positioned through the outer surface 204 to enable inflation and deflation. The air valve 202 is positioned on an upper surface of the inflatable vehicle 200 such that it is above the waterline when the inflatable vehicle 200 is in use. The locking device 100 may be connected to and disconnected from the air valve 202 in an unlocked setting, and further includes a locked setting in which the locking device 100 cannot be removed from the air valve 202. In the locked setting, the locking device 100 provides a secure anchor point for securing the inflatable vehicle 200 to an immovable object.

FIG. 1 shows a tether, in this case a cable 300, connected to the locking device 100 at one end. A loop 302 is provided at the other end of the cable 300 to allow the cable 300 to be passed around a tree 400, thereby securing the inflatable vehicle 100. The cable 300 may be passed around any suitable immovable object, such as a lamppost or other street furniture and secured to the locking device 100 thereby securing the inflatable vehicle 200 to the immovable object, e.g., tree 400. Accordingly, the locking device 100 provides a secure anchor point for tethering the inflatable vehicle 200 so as to prevent theft of the inflatable vehicle 200 when it's not being used. When not being used as an anchor point for securing the inflatable vehicle 200, the locking device 100 may be easily freed from the air valve 202 and stored, for example, in a dry bag. This is in contrast to the fin box attachment of US 2017/0175425 described above that is time-consuming to remove. Alternatively, the locking device 100 may be left in situ on the air valve 202. As the locking device 100 sits above the waterline, it does not affect the hydrodynamic performance of the inflatable vehicle 200, unlike the fin box attachment of US 2017/0175425.

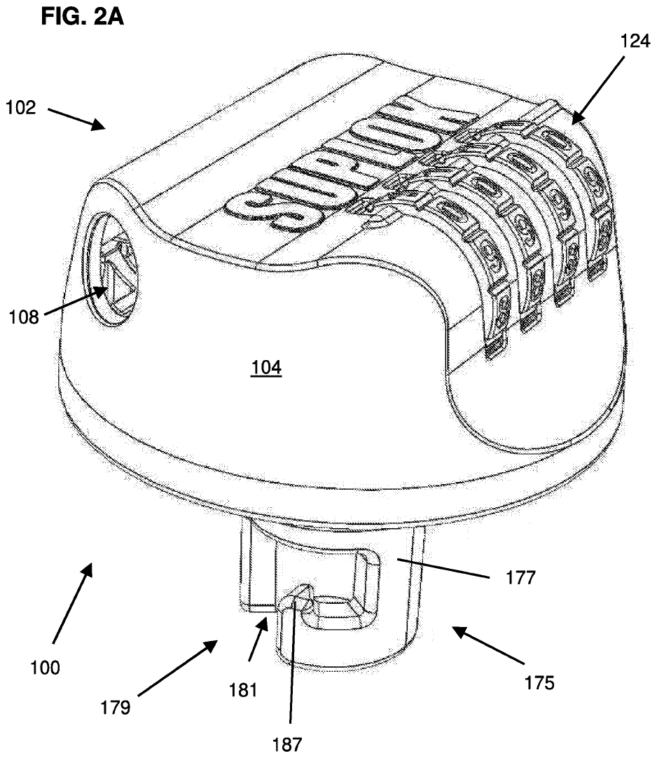

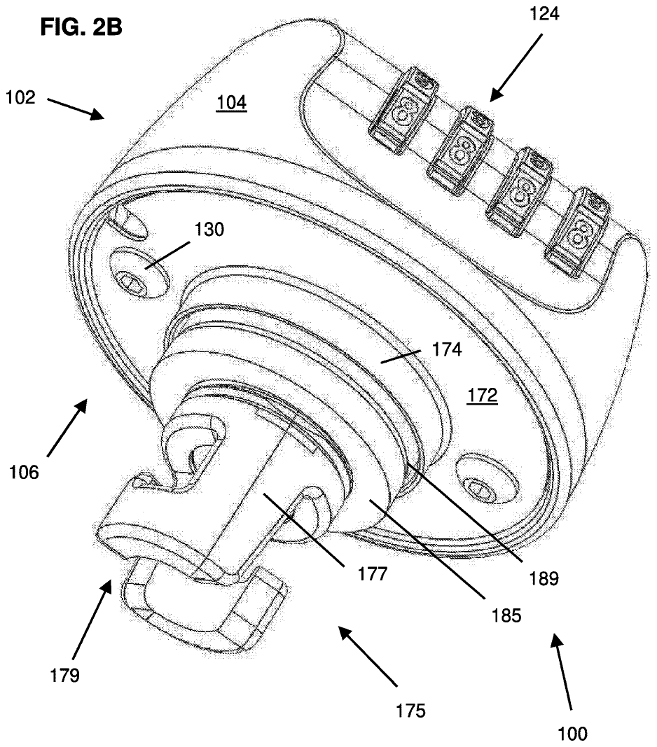

FIGS. 2A and 2B show perspective views of the locking device 100 of FIG. 1. The locking device 100 has a body 102 comprising, externally, a cover 104 and an underside 106. A connector 175 extends from the centre of the underside 106 of body 102. The connector 175 is configured for rotational connection with the air valve 202 of the inflatable vehicle 200, thereby allowing the locking device 100 to be connected to the inflatable vehicle 200.

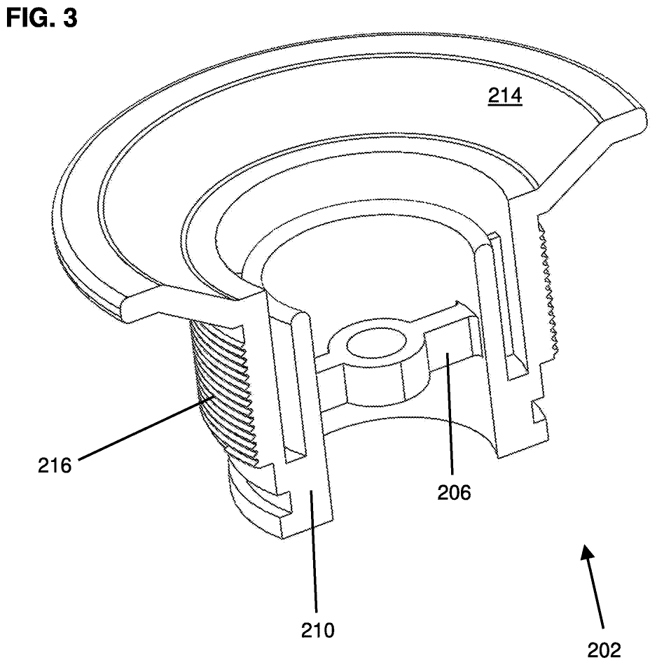

The connector 175 comprises a tubular stem 177 with a bayonet fitting 179 at the end of the stem 177 furthest from the body 102. The bayonet fitting 179 is sized and shaped to connect with the air valve 202, and has two J-shaped slots 181 that rotationally connect with a bridge 206 in the air valve 202 (best seen in FIG. 3). These J-shaped slots 181 may also be any other suitable shape to allow the bayonet fitting 179 to connect with the bridge 206. In other examples, the lower end of the stem 177 may alternatively have a screw thread that co-operates with a screw thread of the air valve 202.

An external screw thread 183 is provided at the end of the stem 177 closest to the body 102 for screwing the stem 177 to a co-operating screw thread 126 provided on a top cap 189 of the connector 175. This top cap 189 forms part of a locking mechanism 120 that couples the body 102 and the connector 175 together in a way that allows selective rotation of the body 102 relative to the connector 175. A seal 185 extends around the end of the stem 177 adjacent the screw thread 183 to ensure a leak-free fit when the locking device 100 is connected to the air valve 202 of the inflatable vehicle 200.

The cover 104 of the body 102 forms a hand grip for a user to grasp and turn to insert and rotate the connector 175 of the locking device 100 into the air valve 202. The cover 104 has an ergonomic surface that may include indentations that make the locking device 100 easier to hold and operate. The cover 104 includes an aperture 108 that opens into a chamber 110 within the body 102 for receiving an actuator to switch the locking mechanism 120 between locked and unlocked settings or configurations. In this example, the cable 300 shown in FIG. 1 acts as the actuator. An end of the cable 300 is inserted into the chamber 110 through the aperture 108, as will be described in further detail below. The locking mechanism 120 includes a combination lock 122 controlled by a set of four numbered, rotatable dials 124 that extend through the cover 104.

The locking device 100 is compatible with inflatable vehicles 200 that have at least one air valve 202. Inflatable vehicles 200 include all suitable forms of inflatable water vehicles 200, such as (but not limited to) stand up paddleboards (SUPs), rafts, canoes, kayaks, dinghies, boats, pool floats and the obstacles that make up water-park assault courses. These inflatable vehicles 200 are formed from a robust, waterproof material. However, bonding other parts to this material provides joints of only limited strength, and so is not particularly useful for attaching an anchor point for a tether.

However, inflatable vehicles 200 must include at least one air valve 202 for inflation and deflation, and this presents an opportunity to attach a locking device 100 to the inflatable vehicle 200 in a way that is secure enough to act as an anchor point. For example, inflatable vehicles 200 usually include a standard type of air valve 202, namely the Halkey Roberts-type valve. Such an air valve 202 is used on virtually all paddleboards. The air valve 202 has a valve body 210 (shown in FIG. 3) and a clamping member (not shown). The valve body 210 and clamping member 212 seal a hole formed through the outer surface 204 of the paddleboard 200. The clamping member 212 is generally ring shaped with a flange at one end. The clamping member 212 is provided with an internal screw thread around its central bore such that the valve body 210 may be screwed onto a co-operating screw thread 216 provided externally on the valve body 210. The clamping member 212 is positioned inside the inflatable vehicle 200 with the edge of the hole resting on the flange of the clamping member 212. The valve body 210 can then be screwed into the clamping member 212. The valve body 210 is also provided with a flange 214 such that, as the valve body 210 and clamping member 212 are screwed together, the edge of the hole formed in the inflatable vehicle 200 is sandwiched between the two flanges to provide a leak-free fit. The edge of the hole is bonded to both flanges to provide a strong joint that stops the air valve 202 from being ripped from the inflatable vehicle 200. The air valve 202 also has a cover (not shown) comprising a bayonet fitting that is rotationally inserted into the valve body 210 to close off the air valve 202, and also to prevent any residual air leaks from the air valve 202.

As can be seen from FIG. 3, the valve body 210 forms an opening to allow air to pass in and out of the inflatable vehicle 200. The bridge 206 spans the opening and supports a one-way spring valve (not shown) that controls air flow into and out of the air valve 202. The spring valve comprises a valve stem extending through a central ring supported by the bridge 206.

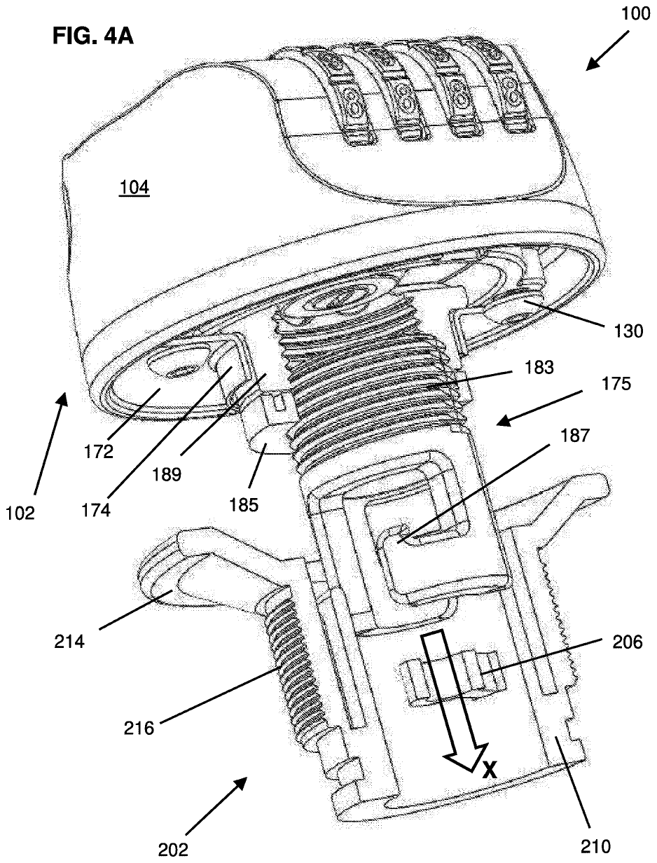

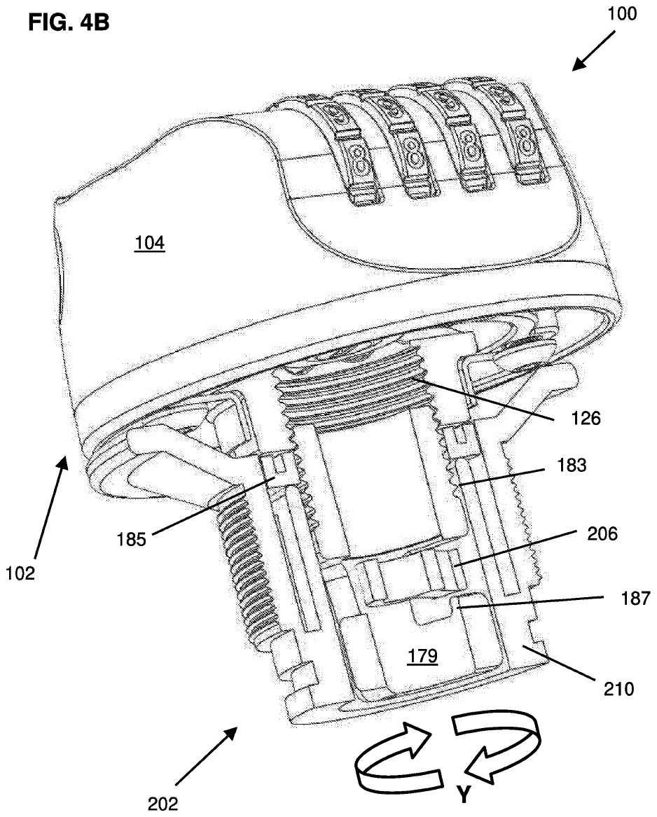

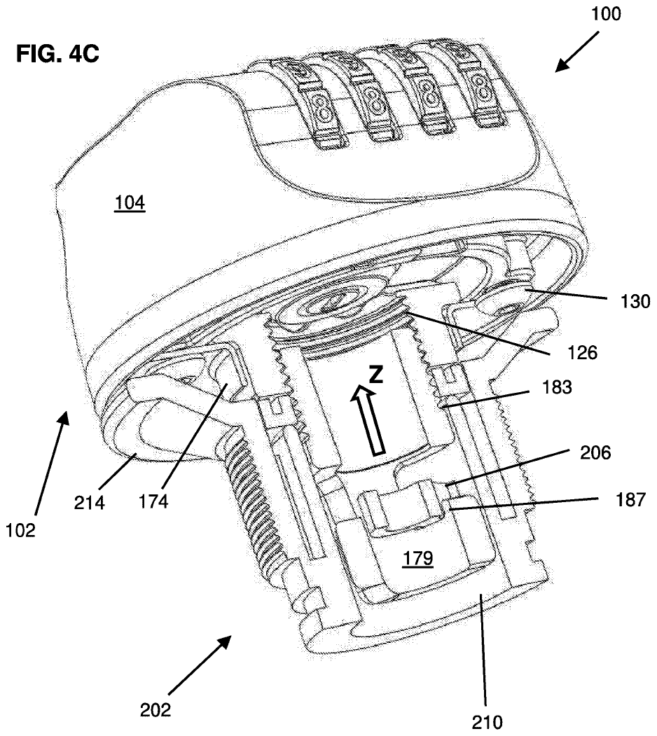

FIGS. 4A-4C show how the locking device 100 is inserted into the air valve 202. As shown in FIG. 4A, the locking device 100 is inserted into the air valve 202, bayonet fitting 179 first, along the direction of arrow X. The connector 100 must be fully inserted into the air valve 202 to allow the bayonet fitting 179 to rotate and lock onto the bridge 206 of the air valve 202. In particular, the J-shaped slots 181 in the end of the bayonet fitting 179 should be aligned with the bridge 206 to allow the locking device 100 to be fully inserted and then twisted clockwise a quarter turn (as per arrow Y of FIG. 4B). As can be seen in FIG. 4B, the length of the connector 175 is such that the underside 106 of the body 102 of the locking device 100 may sit flush with the outer surface 204 of the inflatable vehicle 200, or it may sit close to the outer surface 204.

Once the locking device 100 has been twisted a quarter turn, the sides of the J-shaped slots 181 bearing against the bridge 206 stop further rotation of the connector 175. However, the body 102 may still be turned due to the screw threads 183 and 126 of the stem 177 and the top cap 189 which start to tighten. Continued rotation of the cover 104 of the body 102 ensures the underside 106 of the body 102 sits flush with the outer surface 204 of the inflatable vehicle 200 and draws the stem 177 into the top cap 189 as the screw threads 183 and 126 engage further. As the stem 177 moves back into the top cap 189, the bayonet fitting 179 rises within the air valve 202 (in the direction of arrow Z in FIG. 4C). The bayonet fitting 179 rises such that posts 187 provided at the ends of the J-shaped slots 181 captures the bridge 206 and the bridge 206 is held behind the posts 187. FIG. 4C shows the bridge 206 held in place in the J-shaped slots 181, and comparison of the screw threads 183 and 126 shows how they shift relative positions to draw the bayonet fitting 179 into engagement with the bridge 206. The depth of the screw threads 183 and 126 provides a tolerance in the depth of the air valve 202 from its upper surface to the bridge 206, such that the locking device 100 may work with a variety of valves 202. Seals 185 of different depths may be provided to accommodate a greater variety of valves 202 with different depths.

The underside 106 of the body 102 is or becomes substantially flush with the air valve 202 and the outer surface 204 of the inflatable vehicle 200 adjacent the air valve 202 as the bayonet fitting 179 is drawn into engagement with the bridge 206. The size of the cover 104 corresponds to that of the air valve 202, such that the air valve 202 is concealed beneath the cover 104, preventing access to both the air valve 202 and the connector 175. The bottom edge of the seal 185 makes contact with the outer edge of the air valve 202 to stop air escaping from the inflatable vehicle 200. The seal 185 may be made out of any suitable sealing material, such as rubber.

To remove the locking device 100 from the air valve 202, the body 102 is rotated counter-clockwise (i.e., in the opposite direction of arrow Y of FIG. 4B). This causes the screw threads 183 and 126 of the stem 177 and top cap 189 to unscrew such that the bayonet fitting 179 moves back out from the top cap 189. Eventually, the posts 187 at the end of the J-shaped slots 181 will be clear of the bridge 206 at which point the bayonet fitting 179 will rotate with the cover 104 a quarter turn counter-clockwise. This re-aligns the J-shaped slots 181 with the bridge 206 such that the locking device 100 may be lifted from the air valve 202. This operation may be performed only when the locking device 100 is placed in its unlocked setting.

In the unlocked setting, the body 102 and the connector 175 are coupled together via the locking mechanism 120 so that rotation of the body 102 drives rotation of the connector 175. This allows the cover 104 to be used to screw and unscrew the locking device 100 from the air valve 202, as described above. To prevent removal of the locking device 100 from the air valve 202, the body 102 of the locking device 100 can be selectively decoupled from the connector 175 such that the connector 175 no longer rotates with the body 102 as a user turns the cover 104. This decoupling means that, when the locking device 100 is locked to the inflatable vehicle 200, the body 102 rotates freely whilst the connector 175 remains fully immobilised within the air valve 202.

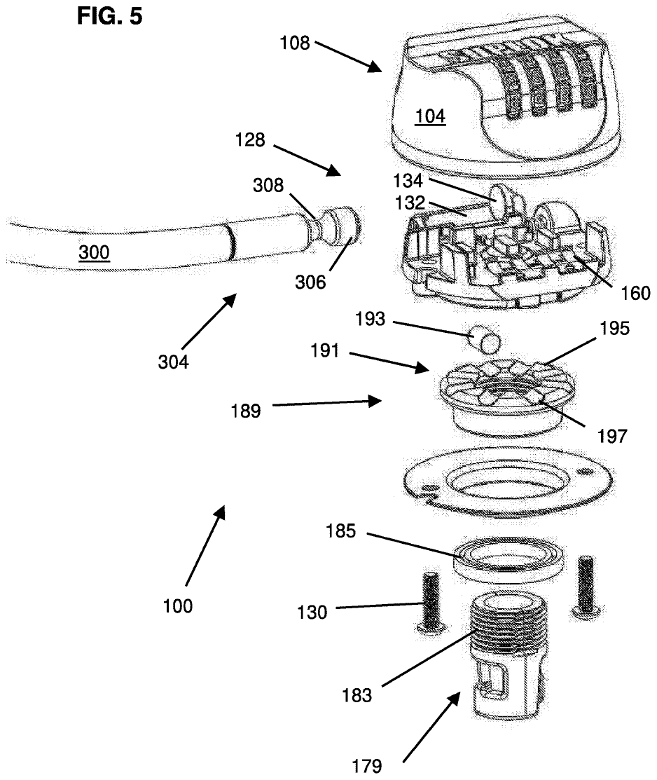

FIG. 5 shows an exploded side view of the locking device 100 of FIGS. 1, 2 and 4. The locking mechanism 120 includes mechanically interlocking formations that may be moved in and out of interlocking configurations. More specifically, the mechanically interlocking formations include a surface of the top cap 189 of the connector 175 that forms a platform 191 for supporting a roller 193. The roller 193 is positioned between the platform 191 and a retainer 128 of the body 102, with the retainer 128 holding the roller 193 in place on the platform 191. The retainer 128 is joined to the body 102 by two bolts 130 so as to rotate with the body 102.

The platform 191 is generally ring-shaped to provide an annular track 195 across which the roller 193 rolls as the body 102 is rotated relative to the connector 175. The track 195 includes eight equally-spaced, radially extending grooves 197 sized to receive a portion of the roller 193 therein. While FIG. 5 shows eight grooves 197, any suitable number of grooves 197 may be used.

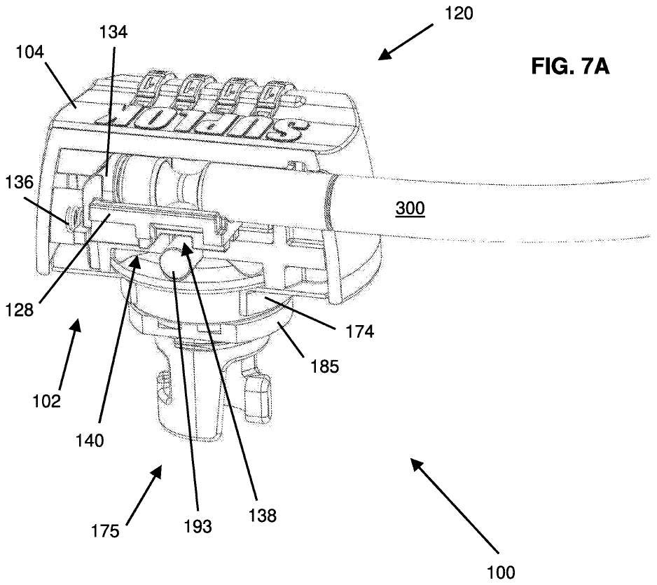

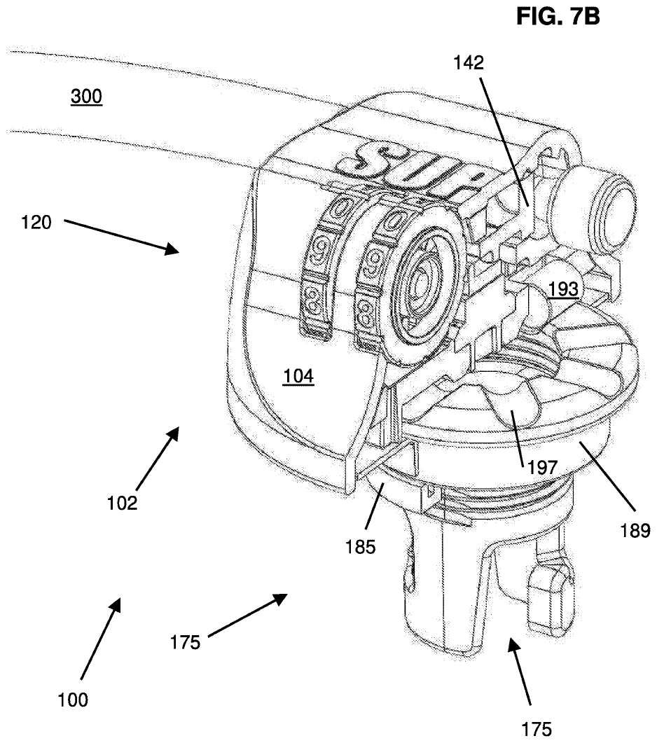

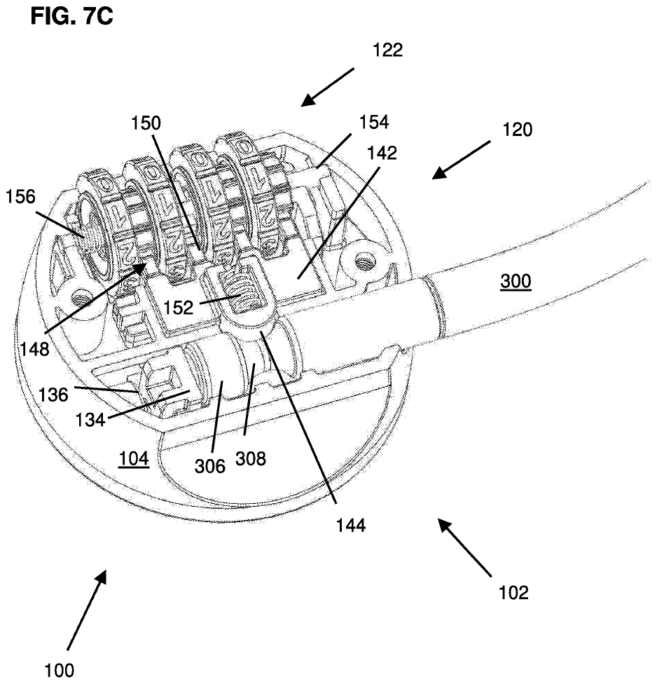

FIG. 7A is a sectional view of the assembled locking device 100 that clearly illustrates how the parts of locking mechanism 120 work together. The roller 193 is shown sat in one of the grooves 197. The side of the retainer 128 facing the roller 193 is provided with a pocket 138 flanked by shoulders 140 that form raised sections. The pocket 138 is aligned with the roller 193 and provides the clearance required for the roller 193 to roll up and over the sections of the track 195 between each groove 197. This corresponds to the locked setting of the locking device 100 where the body 102 is free to rotate relative to the connector 175. In this locked setting, the body 102 spins freely as the body 102 is turned and the connector 175 remains fully immobile in the air valve 202 such that the locking device 100 cannot be unscrewed from the inflatable vehicle 200.

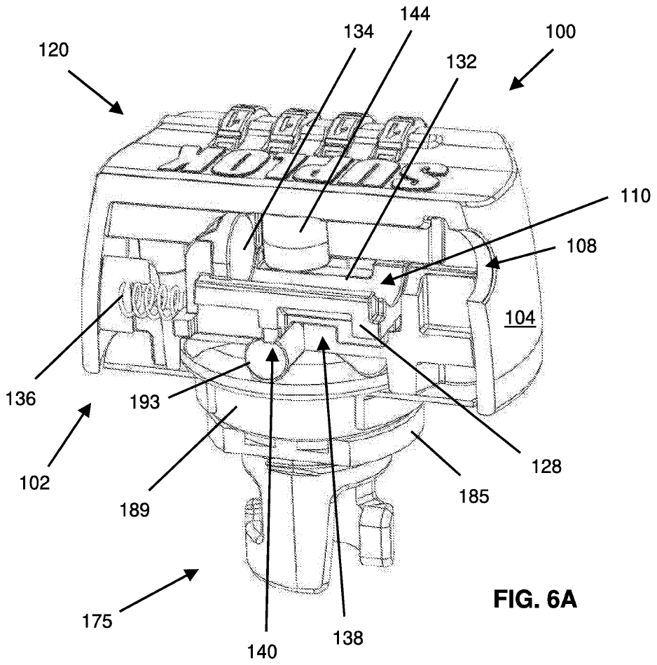

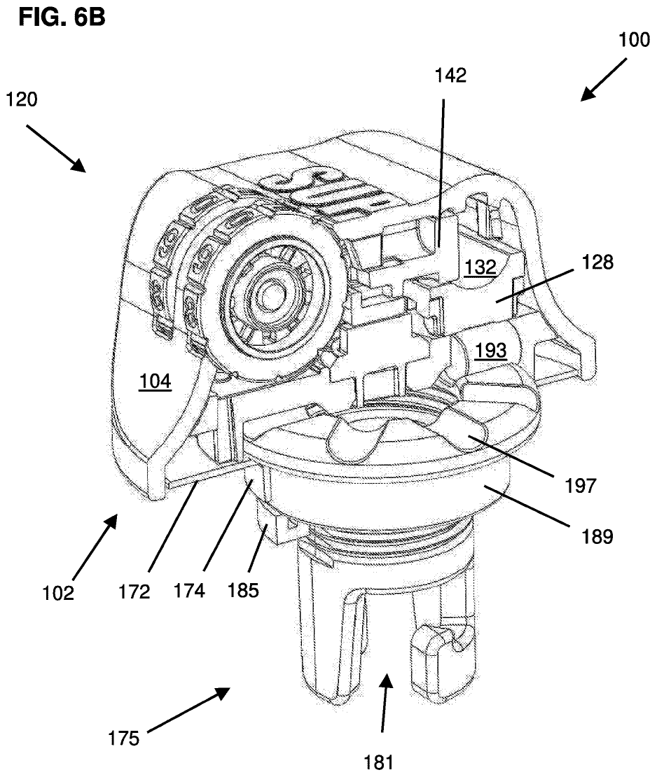

FIG. 6A is a sectional view of the assembled locking device 100 that clearly illustrates how the parts of locking mechanism 120 work together in the unlocked setting. The roller 193 is once again sat in one of the grooves 197. However, the retainer 128 occupies a different position such that the pocket 138 is no longer aligned with the roller 193. Instead one of the shoulders 140 is aligned with the roller 193. In this configuration, there is not sufficient clearance for the roller 193 to roll up and over the sections of the track 195 between each groove 197; instead, the roller 193 is trapped within a groove 197. This means that the body 102 is no longer free to rotate relative to the connector 175. In this unlocked setting, the connector 175 must turn with the body 102 such that the locking device 100 may be screwed into and unscrewed from the air valve 202 of the inflatable vehicle 200.

How the retainer 128 is moved between these settings will now be explained. As described above, the cover 104 has an aperture 108 that opens to a chamber 110 formed within the body 102. The chamber 110 is defined in part by the retainer 128. In particular, the retainer 128 provides the floor 132 and an end wall 134 of the chamber 110 that receives the actuator which, in FIG. 5, is the end of the cable 300. The end of the cable 300 is formed by a rigid cap 304 that has a circular cross section sized to fit through the aperture 108. The rigid cap 304 has a head 306 extending from a narrowed neck 308.

When the cable 300 is pushed into the aperture 108, it slides across the floor 132 provided by the retainer 128 until the head 306 reaches the end wall 134. The cable 300 may then be pushed further into the aperture 108 such that the head 306 moves the end wall 134, and hence the entire retainer 128, against the force of a retainer spring 136. The retainer spring 136 biases the retainer 128 towards the aperture 108. Hence, insertion of the cable 300 moves the retainer 128 from the unlocked setting shown in FIGS. 6A and 6B to the locked setting shown in FIGS. 7A and 7B.

For the locking device 100 of FIGS. 1, 2 and 4 to 7 to operate, there must be a way of securing the cable 300 within the locking device 100. This is achieved using a combination lock 122 that controls movement of a movable barrier 142. As best seen in FIG. 7C, the moveable barrier 142 forms part of a side wall of the chamber 110, and moves in and out of the chamber 110 and hence in and out of the path of the cable 300. The part of the moveable barrier 142 that moves in and out of the chamber 110 forms a detent 144 that is received within the neck 308 of the cable 300, thereby preventing the cable 300 from being removed from the locking device 100 when the combination lock 122 is set to its locked position. A barrier spring 152 biases the movable barrier 142 towards the chamber 110, i.e. with the detent 144 extending into the chamber 110 to engage with the neck 308 of the cable 300, when inserted into the locking device 100.

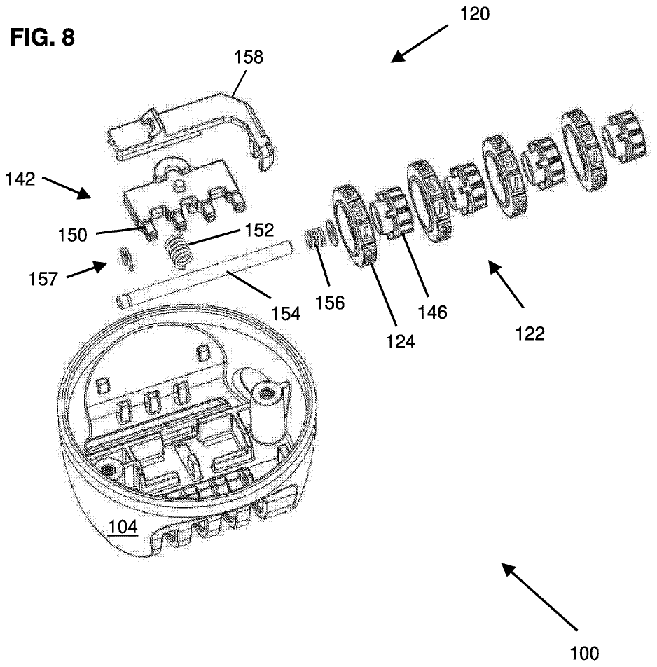

The combination lock 122 works in a standard manner. As shown in FIGS. 7C and 8, the dials 124 are seated on indexed barrels 146 that each include a recess 148. The dials 124 may be rotated to set an unlocking combination on the dials, e.g. 3434. When the correct combination is set, the recesses 148 in the barrels 146 are all aligned with one another, and also with four fingers 150 that extend from the movable barrier 142. The four fingers 150 are on the opposite side of the movable barrier from the detent 144. In this unlocked setting, the fingers 150 of the movable barrier 142 can slide into the recesses 148 which allows the detent 144 to move out of the path of the cable 300. Hence, in the combination lock's unlocked setting, the movable barrier 142 and its detent 144 may move out of the path of the cable 300 as the cable 300 is pushed into the chamber 110.

When the combination is set incorrectly, the combination lock's locked position is set in which at least one of the recesses 148 is not aligned to receive a respective finger 150 of the movable barrier 142. This prevents the movable barrier 142 from moving out of the path of the cable 300. Thus, when the combination lock 122 is set to its locked setting, the cable 300 cannot be pushed all the way into the chamber 110 to move the retainer 128 and change the locking device's setting from unlocked to locked. Also, when a cable 300 is already fully inserted in the chamber 110 and hence retained by the detent 144, the cable 300 may not be withdrawn to allow the retainer 128 to move back under the bias of the retainer spring 136 which would change the locking device's setting from locked to unlocked.

In use, the locking device 100 is screwed into the air valve 202 of the inflatable vehicle 200 without the cable 300 inserted into the chamber 110. The locking device 100 may then be locked into position as follows.

First, the correct combination is set on the combination lock 122 such that the movable barrier 142 is free to move out of the cable's path through the chamber 110.

Then, the cable 300 is pushed into the chamber 110: a chamfered edge to the head 306 of the cable 300 pushes the movable barrier 142 out of the chamber 110, against the bias of barrier spring 152, thereby creating space for the entire head 306 to pass fully into the chamber 110 and engage with and push back the retainer 128 against the retainer spring 136. This puts the locking device 100 into the locked position where the body 102 and connector 175 no longer rotate together (because the pocket 138 of the retainer 128 is now aligned with the roller 193). In this position, the head 306 of the cable 300 has moved beyond the movable barrier 142 such that the barrier spring 152 urges the detent 144 of the movable barrier 142 into the neck 308 of the cap 304 of the cable 300. At the same time, the fingers 150 move out of the recesses 148.

Next, the dials 124 of the combination lock 122 are rotated to scramble the combination. In any scrambled combination, the recesses 148 in the barrels 146 are no longer all aligned to receive the fingers 150 of the movable barrier 142. Thus, it is no longer possible to pull the cable 300 from the locking device 100 thereby securing the cable 300 to the locking device 100. Moreover, the locking device 100 is now in its locked setting where the roller 193 is free to roll around the track 195 from groove 197 to groove 197. This means that the body 102 of the locking device 100 freely rotates and does not transmit any turning force to the connector 175 such that the locking device 100 cannot be unscrewed from the inflatable vehicle 200. Hence, the inflatable vehicle 200 is now securely locked with the cable 300 secured to an immovable object.

To unlock the locking device 100, the dials 124 of the combination lock 122 must first be rotated to display the correct combination, so that the fingers 150 and the recesses 148 align thereby allowing the movable barrier 142 to move out of the way of the cable 300. The cable 300 can then be pulled out of the chamber 110. As the cable 300 is pulled out, the retainer 128 may move back such that a shoulder 140 traps the roller 193 in a groove 197. This ensures that the body 102 and the connector 175 rotate with each other. Hence, the user can now turn the body 102 to unscrew the locking device 100 from the air valve 202 of the inflatable vehicle 200.

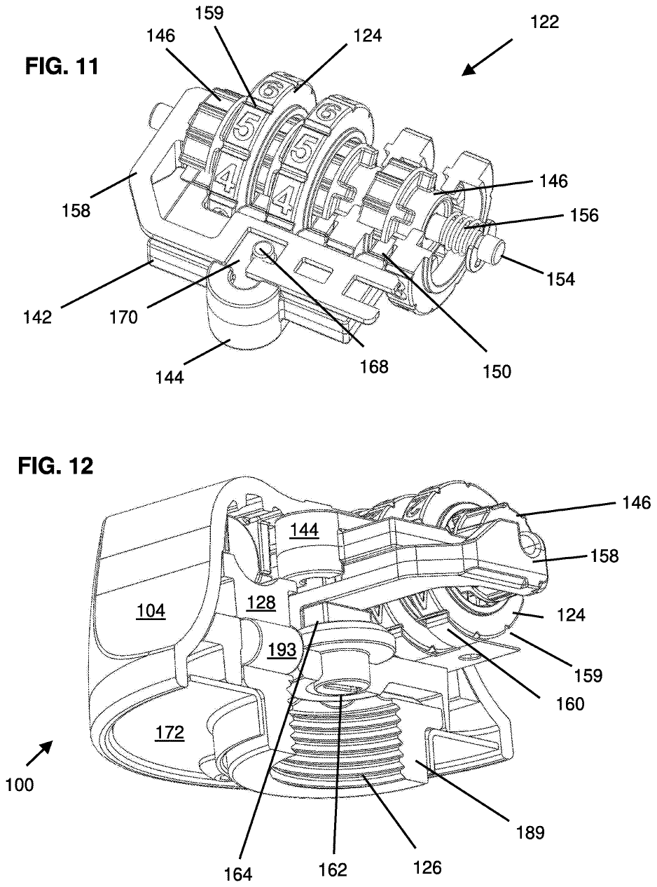

The combination lock 122 includes a reset mechanism. As shown in FIG. 8, the dials 124 are seated on the barrels 146 which, in turn sit on an axle 154 that allows the barrels 146 to rotate. An axle spring 156 is positioned at one end of the axle 154 and pushes against a circlip 157 held in a notch in the axle 154 to urge the barrels 146 against a clamp 158 provided at the other end of the axle 154 (see also FIG. 11). Each dial 124 includes ten numbered faces separated by indents 159. An index spring 160 (shown in FIGS. 5 and 12) is provided for each dial 124, with each leg of the index spring 160 engaging with the indents 159 on a dial 124.

To allow the combination of the combination lock 122 to be changed, a reset switch 162 is provided within the connector 175. The reset switch 162 is provided with a slot such that a flat-based screwdriver or similar may be inserted into the centre of the bayonet fitting 179 and used to turn the reset switch 162. Locating the reset switch 162 on the underside 106 of the body 102, like within the connector 175, prevents access to the reset switch 162 when the locking device 100 is locked in place in the air valve 202 of the inflatable vehicle 200.

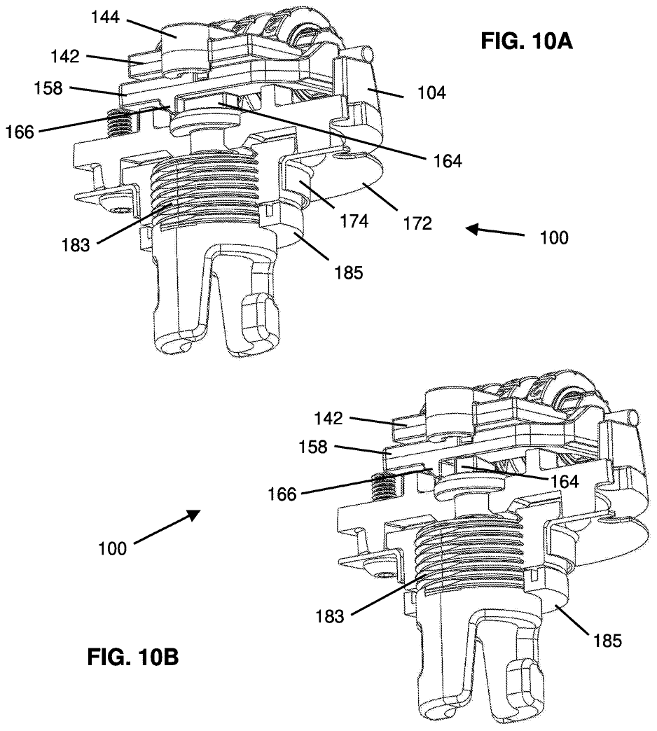

The combination lock 122 can be reset in a standard manner. As shown in FIGS. 10 to 12, the combination lock 122 includes the clamp 158 that may be moved between a clamped position in which it clamps the barrels 146 against the axle spring 156, and an unclamped position in which the axle spring 156 is able to urge the barrels 146 along the axle 154. FIG. 11 shows the clamp 158 in the unclamped position. FIG. 11 also shows that the fingers 150 of the movable barrier 142 are received within the recesses 148, with the dials 124 held in place between the fingers 150 such that the dials 124 cannot slide with the barrels 146. Hence, the dials 124 move out of engagement with the barrels 146 such that the dials 124 may be rotated independently of the barrels 146 to set a new combination. The fingers 150 hold the barrels 146 in position as the dials 124 are rotated, and the index spring 160 ensures alignment of the dials 124 as the new combination is set. With a new combination set, the clamp 158 is moved back into the clamping position which moves the barrels 146 back along the axle 154 and into engagement with the dials 124.

The reset switch 162 operates to allow the clamp 158 to move between the clamped and unclamped positions, as shown in FIGS. 10A and 10B. As can be seen, the reset switch 162 is provided with a cam 164 that contacts one side of the clamp 158. The other side of the clamp 158 acts as a base across which the movable barrier 142 slides. The normal operating position is shown in FIG. 10A in which the wider portion of the cam 164 of the reset switch 162 abuts against a catch 166 provided on the clamp 158. This holds the clamp 158 in its clamped position and prevents it from moving to the unclamped position.

Rotating the reset switch 162 through a quarter turn aligns the narrower part of the cam 164 with the catch 166, thereby providing the space for the clamp 158 to move into the unclamped position. However, for additional security, the combination reset should only be possible when a user has entered the correct current combination. This also ensures that the fingers 150 are received within the recesses 148 of the barrels 146 with the dials 124 held in position between the fingers 150 prior to the barrels 146 sliding along the axle 154. To enable this, the clamp 158 is prevented from moving into the unclamped position before the moveable barrier 142 is moved to the unlocked setting. This is achieved by a peg 168 that extends from the movable barrier 142 into a L-shaped channel 170 provided in the clamp 158, as best seen in FIG. 11 (FIG. 11 shows the reset mechanism upside down relative to FIGS. 10 and 12). FIG. 11 shows the clamp 158 in the unclamped position. In the clamped position, the peg 168 sits in the narrowed entrance to the L-shaped channel 170. As explained above, pushing the cable 300 into the chamber 110 forces the movable barrier 142 out from the chamber 110 and towards the barrels 146. This causes the peg 168 to move from the narrow entrance in the L-shaped channel 170 to the wider portion of the L-shaped channel 170, at which point the axle spring 156 can drive the clamp 158 into the unclamped position shown in FIGS. 11 and 12. In this position, the peg 168 is held in the L-shaped channel 170 which prevents the barrier spring 152 from pushing the movable barrier 142 back away from the barrels 146.

To move the clamp 158 back to the clamped position, the reset switch 162 is rotated through a quarter turn. Rotation of the cam 164 against the catch 166 pushes the clamp 158 back to the clamped position such that the barrels 146 re-engage with the dials 124, preserving the new locking combination. As the clamp 158 moves back to its clamped position, the peg 168 is released from the wider portion of the L-shaped channel 170 and the barrier spring 152 urges the movable barrier 142 to its original position, in the path of the cable 300.

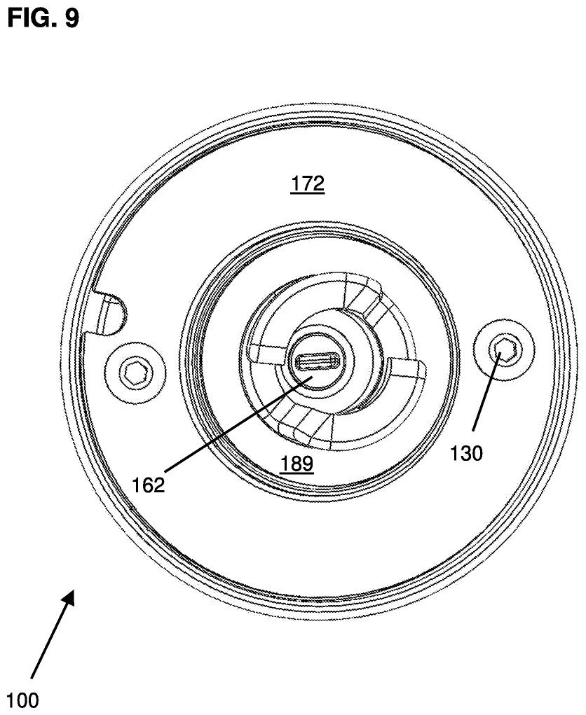

A further feature which can be added to the locking device 100 to aid security is an anti-ligature component. As best seen in FIGS. 2B and 9, an annular retaining plate 172 forms a large part of the underside 106 of the body 102. The retaining plate 172 extends around the top cap 189 of the connector 175, and comprises an inner skirt 174 that overlaps with the top cap 189 (see FIG. 4). Screw holes are provided in the retaining plate 172 to allow the bolts 130 to pass through. The bolts 130 screw into threads provided in the cover 104.

The retaining plate 172 prevents a thief from using a ligature to remove the locking device 100 from the air valve 202. Although the cover 104 provides a flush fit to the inflatable vehicle 200 around the air valve 202, a thief could force a ligature through the minimal gap between the locking device 100 and the air valve 202. However, such a ligature will only tighten around the inner skirt 174 of the retaining plate 172, and so pulling one end of the ligature only serves to turn the body 102; without the skirt 174, the ligature would wrap around the top cap 189 of the connector 175, and so pulling one end of the ligature would turn the connector 175 allowing the locking device 100 to be forced from the inflatable vehicle 200.

The locking device 100 has been described above in relation to use with inflatable vehicles 200, such as inflatable water vehicles. However, the locking device 100 may also be used with on-land inflatable vehicles comprising an air valve.

The locking device 100 has been described above as comprising a cable 300 with a rigid cap 304 at one end and a loop 302 at the other end. The cap 304 serves as the actuator for moving the retainer 128 and putting the locking device 100 into the locked setting. Other forms of tether 300 are possible, provided they have an end that can be inserted into the locking device 100 to act as the actuator.

In some examples, the locking device 100 does not include a tether 300, and is not used to secure the inflatable vehicle 200 to an immovable object. The locking device 100 may lock itself to the inflatable vehicle 200 and then act as a theft deterrent. For example, the locking device 100 may include a motion sensor and an audible and/or visual alarm that activates when the motion sensor detects movement of the locking device 100. The locking device 100 may even have a transmitter to allow an alarm signal to be sent to a remote device, for example to a phone or portable computing device running a suitable app, which would warn an owner of potential theft of the inflatable vehicle.

In addition or as an alternative to the motion sensor and an audible and/or visual alarm, the locking device 100 may include a compartment or holder that is not accessible when the locking device 100 is connected to the inflatable vehicle 200 for housing a tracking device such as an Apple Airtag (RTM). Such tracking devices send signals to remote devices, such that the location of the locking device 100 and hence inflatable vehicle 200 may be tracked by the owner.

In examples not including a tether 300, an alternative actuator is used to move the retainer 128 and put the locking device 100 into the locked setting. For example, the actuator may be a part of the body 102, such as a button that extends through the cover 104 such that one end is accessible to the user and the other end may move through the chamber 110 to engage with the end wall 134 of the retainer 128. The other end of the button may have the same head 306 and neck 308 arrangement as already described for the cable 300. Also, where an integral actuator like the button just described is provided, a loop may be formed in the cover 104 to allow a tether to be fed through and secured to the locking device 100: in this case, the tether would itself have to be secured, for example using a separate padlock.

The locking device 100 has been described above as comprising a combination lock. However, other types of locks may be used such as keyed locks or electronic locks, such as electronic locks that are remotely activated such as by a RF signal.

1. A locking device comprising:
a body including a cover and an underside; and
a connector configured for rotational connection; wherein:
the connector extends from the underside and is rotationally coupled to the body via a locking mechanism, such that:
when the locking device is in an unlocked setting, the locking mechanism couples the body and the connector in an engaged configuration such that rotation of the body causes the connector to rotate with the body; and
when the locking device is in a locked setting, the locking mechanism couples the body and the connector in a disengaged configuration such that rotation of the body does not cause the connector to rotate with the body.

2. The locking device of claim 1, wherein:
the connector comprises a bayonet fitting sized and shaped to connect with a standard inflatable boat fill and deflate valve such as a Halkey Roberts-type valve; and
the cover has a size and shape larger than the valve and the connector has a depth such that, when the locking device is in the valve and in the locked setting, the underside of the body is substantially flush with the valve.

3. The locking device of claim 1 or 2, wherein the locking mechanism comprises mechanically interlocking formations that are configured to be moved between the engaged configuration where they interlock to ensure the connector rotates with the body, and the disengaged configuration where the interlocking formations are clear of each other to ensure that the rotation of the body does not cause the connector to rotate with the body.

4. The locking device of claim 3, wherein the interlocking formations comprise:
a platform joined to the connector so as to rotate with the connector;
a roller supported by the platform; and
a retainer joined to the body so as to rotate with the body; and wherein:
the platform is provided with a track across which the roller may roll as the body is rotated relative to the connector when the locking mechanism is in the disengaged configuration;
the track includes a radially-extending groove sized to receive at least a portion of the roller therein; and
the retainer is arranged to face the groove and to move between the engaged and disengaged configurations, and:
in the disengaged configuration, the portion of the retainer aligned with the groove provides sufficient clearance for the roller to roll out from the groove, around the track and back into the groove such that the connector does not rotate with body as the body is rotated, and
in the engaged configuration, the portion of the retainer aligned with the groove restricts the clearance of the roller in the groove thereby preventing the roller from rolling out of the groove such that the connector rotates with the body as the body is rotated.

5. The locking device of claim 4, wherein the surface of the retainer facing the groove is stepped to provide a pocket flanked by raised sections and the retainer is arranged to translate between the disengaged configuration in which the pocket is aligned with the groove to provide the clearance for the roller to roll out from the groove, and the engaged configuration in which one of the raised sections is aligned with the groove so as to prevent the roller from rolling out of the groove.

6. The locking device of claim 4 or 5, wherein the platform comprises further radially-extending grooves such that, when the locking mechanism is in the disengaged configuration, the roller may roll from groove to groove as the body is rotated relative to the connector.

7. The locking device of claim 5 or 6, wherein the cover further comprises an aperture opening into a chamber within the body defined in part by the retainer, and the retainer is configured to translate from the engaged configuration to the disengaged configuration when an actuator is pushed into the chamber.

8. The locking device of claim 7, wherein the retainer is resiliently biased towards the engaged configuration.

9. The locking device of claim 7 or 8, further comprising a movable barrier configured to be moved in and out of the path of the actuator as the actuator is pushed through the chamber, wherein the movable barrier is controlled by a lock which, in the lock's locked position, prevents the movable barrier from being moved out of the actuator's path and, in the lock's unlocked position, allows the movable barrier to be moved out of the actuator's path.

10. The locking device of claim 9, wherein the movable barrier is resiliently biased towards the lock's locked position.

11. The locking device of claim 10, wherein the actuator comprises a head that moves the movable barrier as the actuator is pushed through the chamber and a neck that allows the movable barrier to move back due to the resilient biasing thereby keeping the retainer in the disengaged configuration when the lock is set to the lock's locked position.

12. The locking device of any of claims 9 to 11, wherein the lock comprises a combination lock positioned in the cover of the body, the combination lock including a set of rotatable dials that rotate to set the position of respective recesses, the movable barrier comprises a finger for each of the dials and, when the combination is set correctly, the lock's unlocked position is set in which the recesses are aligned to receive the fingers as the movable barrier moves out of the path of the actuator and, when the combination is set incorrectly, the lock's locked position is set in which at least one of the recesses is not aligned to receive a respective finger such that the movable barrier cannot move out of the path of the actuator.

13. The locking device of claim 12, wherein the body of the locking device further comprises a reset switch configured to reset the combination lock, and the reset switch is located on the underside of the body or within the connector.

14. The locking device of claim 13, wherein the dials sit on indexed barrels that include the recesses, and the reset switch may be turned to a reset position to move a clamp that then allow the dials to move clear of their barrels and to be rotated independently of the barrels to set a new combination, and the reset switch may be turned back out of the reset position such that the dials are moved back onto their barrels by the clamp in the newly-set combination.

15. The locking device of claim 14, wherein the movable barrier co-operates with the clamp such that the clamp may only move into the reset position when the locking mechanism is in the disengaged configuration.

16. The locking device of any one of claims 7 to 15, wherein the actuator comprises a motion sensor with an alarm, and optionally, wherein the alarm is configured to send visual or audible signals when the motion sensor detects movement.

17. The locking device of any preceding claims, further comprising a tracking device configured to send tracking signals and, optionally, wherein the tracking signals are Bluetooth and/or RFID signals.

18. A system comprising:
an inflatable vehicle comprising an air valve; and
a locking device comprising:
a body including a cover and an underside; and
a connector configured for rotational connection with the air valve; wherein:
the connector extends from the underside and is rotationally coupled to the body via a locking mechanism, such that:
when the locking device is in an unlocked setting, the locking mechanism couples the body and the connector in an engaged configuration such that rotation of the body causes the connector to rotate with the body; and
when the locking device is in a locked setting, the locking mechanism couples the body and the connector in a disengaged configuration such that rotation of the body does not cause the connector to rotate with the body.

19. The system of claim 18, wherein the cover has a size and shape larger than the air valve and the connector has a depth such that, when the locking device is in the air valve and in the locked setting, the underside of the body is substantially flush with the air valve and the outer surface of the inflatable vehicle adjacent the air valve.

20. The system of claim 18 or 19, wherein:
the locking mechanism comprises mechanically interlocking formations that are configured to be moved between the engaged configuration where they interlock to ensure the connector rotates with the body, and the disengaged configuration where the interlocking formations are clear of each other to ensure that the rotation of the body does not cause the connector to rotate with the body;
the interlocking formations comprise:
a platform joined to the connector so as to rotate with the connector;
a roller supported by the platform; and
a retainer joined to the body so as to rotate with the body; and wherein:
the platform is provided with a track across which the roller may roll as the body is rotated relative to the connector when the locking mechanism is in the disengaged configuration;
the track includes a radially-extending groove sized to receive at least a portion of the roller therein; and
the retainer is arranged to face the groove and to move between the engaged and disengaged configurations, and:
in the disengaged configuration, the portion of the retainer aligned with the groove provides sufficient clearance for the roller to roll out from the groove, around the track and back into the groove such that the connector does not rotate with body as the body is rotated, and
in the engaged configuration, the portion of the retainer aligned with the groove restricts the clearance of the roller in the groove thereby preventing the roller from rolling out of the groove such that the connector rotates with the body as the body is rotated;
the surface of the retainer facing the groove is stepped to provide a pocket flanked by raised sections and the retainer is arranged to translate between the disengaged configuration in which the pocket is aligned with the groove to provide the clearance for the roller to roll out from the groove, and the engaged configuration in which one of the raised sections is aligned with the groove so as to prevent the roller from rolling out of the groove;
the system further comprises a tether;
the cover further comprises an aperture opening into a chamber within the body defined in part by the retainer, and the retainer is configured to translate from the engaged configuration to the disengaged configuration when an end of the tether is pushed into the chamber.

21. The system of claim 20, wherein the other end of the tether comprises a loop.

22. The system of any of claims 18 to 21, wherein the inflatable vehicle is an inflatable boat, optionally a stand-up paddle board, a canoe or a kayak.
